(19) United States
(12) Patent Application Publication
(10) Pub. No.: US 2010/0201467 A1
(43) Pub. Date: Aug. 12, 2010

(54) MAGNETICALLY ACTUATED ELECTRIC SWITCH

(75) Inventor: Joachim Hentschel, Weitramsdorf-Weidach (DE)

Correspondence Address: OSHA LIANG L.L.P., TWO HOUSTON CENTER, 909 FANNIN, SUITE 3500, HOUSTON, TX, 77010, US

(73) Assignee: VALEO KLIMASYSTEME GMBH, Rodach (DE)

(21) Appl. No.: 12/602,343

(22) PCT Filed: Jun. 2, 2008
(86) PCT No.: PCT/EP2008/004384

§ 371 Date: Nov. 30, 2009

(30) Foreign Application Priority Data
May 31, 2007 (DE) 10 2007 025 279.1

(51) Int. Cl. H01H 9/00

(52) U.S. Cl. 335/205

(57) ABSTRACT

Disclosed is a switch for manually switching electric contacts, comprising a control element (10) that can be displaced by means of a movement, and a contact element (20; 20a, 20b) which can be moved along a first contact path (40) by means of the movement of the control element (10). The control element (10) and the contact element (20; 20a, 20b) mutually interact in a contactless and direct manner.

The invention relates to switches for electric contacts. The invention specifically relates to switches for switching electric contacts manually.

In modern devices, operation of operator control elements is becoming evermore important. The haptics and the acoustics are of central significance here. In particular for the operation of vehicles, but also equally well for many other devices with electrical functions, the ease of operation of switches and controllers is both relevant to safety and an important criterion for the quality and impression of quality of the entire device. The impression of quality has become a decisive factor in sales not only in motor vehicles.

Operator control elements such as switches or controllers should be easy to switch but at the same time during the switching process they should provide the user with the sensation that the switch, and therefore an electrical contact, has been moved into the desired position, in which respect both the mechanical sensation when the switch is operated and, on the other hand, the associated sounds are highly significant. At the same time, the switches should function reliably over long time periods in a wide variety of climatic conditions.

Conventional switches have for this purpose latching mechanisms in which a switching element which is mechanically connected to an operator control element can latch into one or more detents. Here, each of the detents corresponds to a switch position. The switching element has contacts which, in the respective position, bring about the electric contacts which are necessary for the switching function.

Spring force is applied here to the switching element in the direction of the detents by means of coil springs or leaf springs, with the result that the switching element engages in the detent when it is moved into its vicinity. The movement of the switching element is carried out here by means of an operator control element which is mechanically connected to the switching element directly or via levers and joints.

The operator control element is typically mounted here on the operator control panel or the dashboard of the device, with the result that it can easily be activated by a user. The mechanical connection of the operator control element to the contact element or switching element has the disadvantage here that openings have to be provided in the switch for mechanical movements of the elements, as a result of which dirt and moisture can penetrate into the switch. Depending on the conditions of use of the switch, penetrating dust, sand and other impurities can adversely affect the mechanical function, in particular the ease of movement of the switch. Furthermore, penetrating moisture can bring about corrosion or even short circuits at the contacts.

Encapsulated switches are known for overcoming these disadvantages. However, said switches have the disadvantage that the operator control element is also encapsulated, which has a very adverse effect on the visual appearance and therefore the design possibilities. If the operator control element is to be located outside the encapsulation, special seals are required, which usually limit the service life of the switch, influence the ease of movement of the switch and adversely affect the switching sensation.

Furthermore, mechanical connections have the disadvantage that in the course of time they erode due to material friction, and the switching sensation and the impression of quality are degraded by this.

The object of the present invention is therefore to make available an improved switch for manually switching electric connections.

This object is achieved by a switch for switching electric contacts or electric connections manually, comprising an operator control element which can be displaced manually by means of a movement, and at least one contact element which can be displaced along a first contact path by means of the movement of the operator control element, wherein the operator control element and the contact element interact directly with one another in a contactless fashion, with the result that the contact element follows the movement of the operator control element.

The contactless interaction here allows levers, joints and other mechanical force transmitting elements to be dispensed with, as a result of which the mechanical erosion and the wear are minimized. The interaction is direct here, i.e. a movement of the operator control element is translated directly into a movement of the contact element or switching element, with the result that the contact element always follows the movement of the operator control element. Direct movement is to be understood as meaning in particular that no intermediary elements such as electric connections or lines are provided between the operator control element and the switching element.

The term interaction can also have a further meaning here, i.e. a movement of the switching element or contact element is also transmitted to the operator control element in the opposite direction. If, for example, the contact element is moved into a detent or depression, less force is necessary for this than if the contact element is to be moved out of the detent or depression. The interaction can transmit feedback to the operator control element via the necessary actuating force, and therefore to the user.

Manual switching means here that the operator control element is activated mechanically, for example, by a user's hand. The operator control element can be grasped directly by the user here, and knobs and paneling such as are generally known can be provided here.

The interaction can be magnetic. The operator control element can, for this purpose, be magnetic in at least one section, for which purpose a permanent magnet or an electromagnet can be provided on the operator control element. The switching element or contact element can, on the other hand, be magnetizable and have, for example, a ferromagnetic or paramagnetic section and be made, for example, from iron. This provides the advantage that the contact element can be used simultaneously for bringing about the electric contact.

According to the invention, the contact element can, however, also comprise a magnetic section, and the operator control element can be magnetizable. Both the operator control element and the contact element can also be magnetic. In this case, the magnetic interaction can be attraction or repulsion, and it may even be possible to switch it over if electromagnets are used. Various switch functions can be implemented by virtue of the various magnetizations. It is also possible to provide a plurality of contact elements which are dependent on one another or independent of one another, as a result of which it is possible to provide various switching functions with the same operator control element.

For a person skilled in the art it is clear that it is possible to have a large number of combination possibilities of the magnets, which permit a large number of embodiments.

The interaction, in particular a magnetic interaction, allows the contact element to be forced at least against the first contact path. As a result, the contact element is held against the first contact path, and no further spring elements such as screws or leaf springs are required.

The switch can also have a second contact path or further contact paths which can be arranged, for example, in parallel. In particular, the first contact path and the second contact path can be arranged parallel to one another. Further contact paths can also be arranged parallel thereto or in series with the second contact path. The contact element can rest on the contact paths and, if appropriate, be held against the contact paths by means of magnetic force.

The contact paths can have contact faces with which the contact element surrounds an electrically conductive section which can be placed in electric contact by means of the first movement. The contact faces are each connected here to electrical contacts, connections or terminals.

For example, the second contact path can have a contact face over one of its lengths, with the result that when the contact element rests on the second contact path it is in electric contact with the contact element. An electrical potential, which the second contact path is at, because, for example, it is connected to a power supply, is therefore transmitted to the contact element.

The first contact path can have one or more contact faces, wherein each contact face corresponds to a switch position and can have in each case an electric connection, for example to a load. The contact faces can be arranged one after the other along the first contact path, and the person skilled in the art can adapt the arrangement here according to the respective requirements. Moving the contact element along the first contact path then causes the contact element to be displaced with respect to the contact faces, and to come into electric contact with none of the contact faces, one contact face or even a plurality of contact faces, depending on the position of the contact element, as a result of which the respective contact face is raised to the electrical potential of the contact element, and electric contact or an electric connection is brought about in accordance with the switch position.

The contact paths, in particular the first and/or the second contact path, can comprise at least one notch, wherein the at least one notch corresponds to a switch position. In the switch position, the contact element can be located in the at least one notch, and can bring about corresponding electric contact depending on the notch. If the contact element is moved along the contact paths, where comes a higher force must be applied in order to move the contact element out of the notch, while without a further application of force it is moved by means of the operator control element into the notch or retained therein. This allows a latching arrangement of the switching path.

In this context, a relatively large force is necessary to move the contact element out of the notch, and this can be transmitted to the operator control element and the user via the interaction, and the user is therefore provided with feedback about the switched position.

The notches can also be provided with contact faces, with the result that contact is brought about only if the contact element is in the respective notch. In this case, the notches correspond to switch positions to which electrical switch states are assigned.

In this context, the notches are advantageously arranged in the direction of the magnetic force, with the result that the contact element is pulled by the magnetic force into the notches if the operator control element does not move.

One or more notches may be provided on the first and the second and/or further contact paths here, or on just one of the contact paths. A person skilled in the art will adapt the number and arrangement of the notches to the respective requirements made of the switch here.

The contact element and at least the first contact path may be arranged in an enclosed housing, with the operator control element being arranged outside the housing. By arranging the contact element and the first and, if appropriate, the second and the further contact paths within the housing it is possible for all the elements which are important for the electrical switching to be accommodated in the housing and therefore be protected.

The housing may be enclosed completely and also in an airtight and/or watertight fashion here, with the result that the electrical components are completely encapsulated. Since the contact element is displaced by means of the contactless interaction from outside the housing, it is not necessary to transmit any mechanical movements whatsoever from outside into the housing for the purpose of switching. It is therefore not necessary to provide openings in the housing or movable housing sections, which facilitates the sealing of the housing. Only electric connections such as, for example, electric cables have to be led through the housing wall, and a person skilled in the art is familiar with suitable seals for this purpose.

The housing can protect the electrical components effectively and permanently against environmental influences, in particular against dust and moisture. Depending on the housing used, this permits enduring and reliable use in dusty or else in moist or wet environments.

The first contact path and/or the second contact path may be arranged on a printed circuit board. The contact paths here may be in the form of sliding contacts by means of which the contact element is moved. The contact paths may be integrated into the printed circuit board (PCB) or attached thereto using known techniques.

The switch according to the invention can, however, also be embodied without a printed circuit board by making contact with the contact elements directly by means of electric lines or cables.

In one embodiment of the invention, the operator control element is mounted so as to be rotatable about a rotational axis, and is, for example, in the form of a rotary switch. In this case, a magnet can also be arranged on the rotational axis or radially with respect to the rotational axis, with the result that when the operator control element carries out a rotational movement said magnet moves along a circular arc.

One or more of the contact paths can, for this purpose, also be arranged in the form of a circular arc about the rotational axis. As a result, the contact element can move along the circular-arc-shaped contact paths, likewise essentially along a circular arc, if the operator control element is rotated and therefore, if appropriate, the magnet is moved in the form of a circular arc.

The magnet and the contact element may be oriented along the rotational axis here, and move essentially on the same radius about the rotational axis.

In one preferred embodiment, the contact element is arranged radially with respect to the rotational axis of the operator control element. If the embodiment implies a magnet, the contact element is also arranged radially with respect to the magnet and moves essentially on a circular arc about the magnet.

The contact element may be advantageously arranged or oriented parallel to the rotational axis of the rotational movement here.

The operator control element and the contact element can be capable of being displaced linearly essentially parallel to one another. The linear movement of the operator control element relates here essentially to the magnet or the magnetizable section arranged on the operator control element. As a result, sliding controllers and sliding switches can be implemented with the invention.

Further features and advantages of the invention become clearer on reading the following, merely exemplary and non-restrictive description of a preferred embodiment, which is given with reference to the figures, in which:

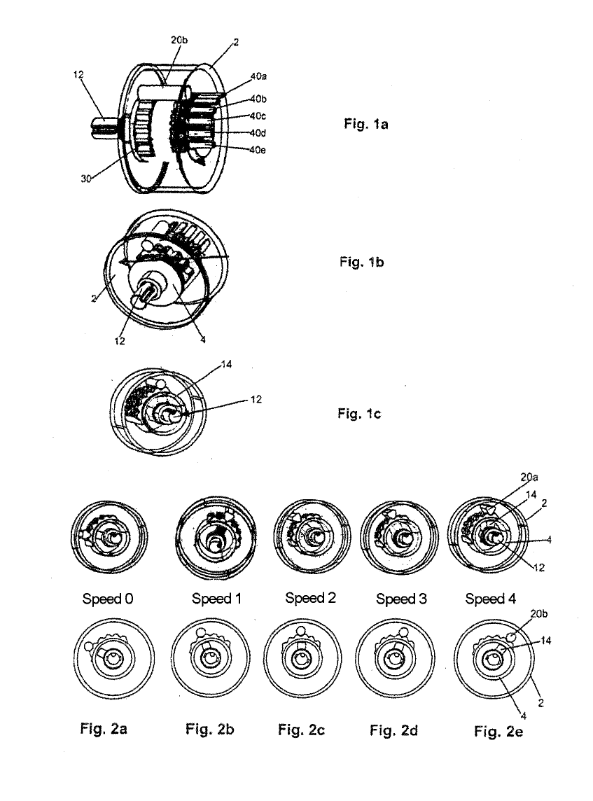

FIGS. 1a, 1b and 1c show a switch according to the invention from various perspectives;

FIGS. 2a to 2e show a switch according to the invention in four different switched positions, in each case in a perspective view and in cross section;

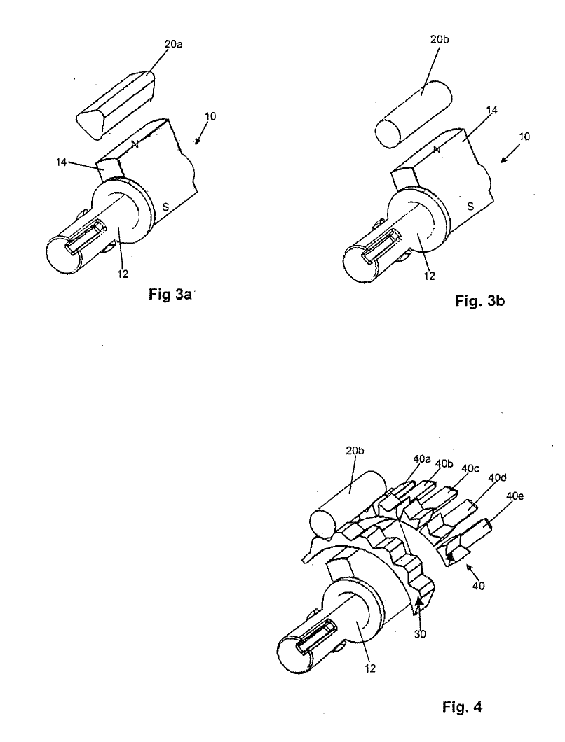

FIG. 3a shows an operator control element and a contact element with a three-sided cross section, and FIG. 3b shows an operator control element and a contact element with a circular cross section; and

FIG. 4 shows the operator control element and the contact element from FIG. 3b with contact paths.

Identical or similar parts are denoted by the same reference symbols in the figures and in the description.

FIGS. 1a, 1b and 1c show a switch according to the invention from various perspectives. The switch comprises a cylindrical outer housing 2 and a cylindrical inner housing 4. The inner housing 4 is arranged inside the outer housing 2 on the same cylinder axis. The inner housing 4 can also be composed of just the lateral surface of the cylinder here, with the end sides being omitted, as illustrated in FIG. 1c. Both housings can be made of a plastic or of some other, preferably insulating material.

Furthermore, the switch comprises an operator control element 10 having a shaft or an axle 12 on which a permanent magnet 14 is arranged.

A first contact path 40 and a second contact path 30 are arranged along a circular arc on the lateral surface of the inner housing 4. The first contact path is comprised here of a plurality of contact faces 40a, 40b, 40c, 40d, 40e, with each contact face having a notch. The second contact path 30 is in one piece, made of electrically conductive material or has an electrically conductive surface and comprises the same number of notches as the first contact path 40. The notches are oriented here in such a way that a contact element 20 can engage in each case in a notch in the first contact path 40 and in a notch in the second contact path 30.

The various notches and contact faces 40a, 40b, 40c, 40d, 40e in the first contact path 40 each correspond to a switch position. Various switch positions are illustrated in FIGS. 2a to 2e.

In FIG. 2a, the switch is shown in the zero position. It corresponds to the switch position in FIGS. 1a and 1b. Here, the contact element 20 is located in a first notch with a first contact face 40a of the first contact path 40, and in the corresponding notch of the second contact path 30. In this position, a connected load, for example a blower, can be switched off. In this case, it is not necessary to provide an electric connection on the first contact path 40a.

In FIG. 2b, the switch is shown in a first switched position. The contact element is located in the second notch with the contact face 40b of the first contact path 40 and in the corresponding notch in the second contact path 30. This position may correspond, for example, to a first speed of a blower, in which case the contact face 40b can be connected to the blower via a resistor. Other connection possibilities are known to a person skilled in the art.

FIGS. 2c, 2d and 2e correspondingly show a second, third and fourth switch position, with the contact element 20 being in the third, fourth or fifth notch with a corresponding contact face 40c, 40d, 40. In the case of the blower, these then correspond to further blower stages and can also be connected to the blower without a resistor with or in the highest stage.

FIGS. 2a to 2e also show that when the operator control element 10 moves, the shaft 12 and magnet 14 thereof are displaced, and that the contact element 20 is displaced in accordance with this movement. In this context, there is no material connection between the contact element 20 and operator control element 10. Instead, the operator control element 10 and contact element 20 are mechanically separated from one another by the inner housing 4.

The transmission of forces from the operator control element 10 to the contact element 20 and conversely is carried out here by means of magnetic interaction or by means of magnetic forces such as those illustrated in FIGS. 3a and 3b.

FIGS. 3a and 3b show here the operator control element 10, composed of the shaft 12 and the magnet 14, and the contact element 20 in more detail, with further elements of the switch according to the invention having been omitted for illustration purposes.

FIGS. 3a and 3b differ here in the embodiment of the contact element 20, with a contact element with a three-sided cross section 20a being illustrated in FIG. 3a, and a contact element with a circular cross section 20b being illustrated in FIG. 3b. As a result of the different shapes, the engagement of the contact element 20, 20a or 20b in the notches can be changed and adapted to different requirements.

The three-sided or polygonal shape of the contact element 20a permits more accurately fitting engagement in the notches in the contact paths 30, 40, as a result of which the actuating accuracy and the forces which are necessary for the adjustment are increased. In addition, the bearing face and therefore the contact face of the contact element 20a with the corresponding contact path are improved.

On the other hand, the round shape of the contact element with a circular cross section 20b permits smaller forces for switching between the switched positions, and also allows the contact element 20b to be able to roll over the contact paths 30, 40. This is advantageous, in particular, when there are no notches provided on the contact paths 30, 40. In this context, a continuous controller such as a potentiometer may, for example, also be implemented in a manner known per se.

The shape of the contact element and of the notch also permits the acoustics when switching the switch, for example when it latches in the notches, to be changed or minimized and adapted according to requirements.

The shape of the contact element and the arrangement and shape of the contact paths illustrated in the exemplary embodiments are only exemplary here and are not restrictive of the invention. A person skilled in the art recognizes here that the invention can be used with a plurality of further shapes and arrangements.

The contact elements 20, 20a, 20b are made here of a magnetizable material such as, for example, iron, or comprise a permanent magnet. The contact element 20, 20a, 20b is attracted here by the permanent magnet 14 of the operator control element 10. As illustrated in FIG. 4, the contact element 20, 20a, 20b is therefore forced against the contact paths 30, 40, and said contact element 20, 20a, 20b is, if appropriate, pulled into the notches of the contact paths.

If the contact element experiences a force when it is moving in or out of the notches, this can also be felt via the magnetic interaction back onto the operator control element, and therefore by the user.

If the operator control element 10 and therefore the magnet 14 are then rotated, the contact element 20, 20a, 20b follows the magnet on the circular arc predefined by the contact paths 30, 40. In the process, the contact element 20, 20a, 20b is also pulled into the notches, and a correspondingly higher force of the operator is necessary to move the contact element 20, 20a, 20b further, as a result of which a latching sensation is produced for the operator.

Furthermore, the contact element 20, 20a, 20b is made of an electrically conductive material or comprises such a section. The latter brings about an electric connection between the second contact path 30 and the respective contact face 40a, 40b, 40c, 40d, 40e of the first contact path 40. For example, the second contact face 30 may be in one piece made of a conductive material and be connected to a power supply. The second contact face 30 and the contact element 20, 20a, 20b resting thereon are then at the electrical potential of the voltage source. In the position illustrated in FIG. 4, the contact element is located in the notch in the contact face 40a. The contact face 40a corresponds here to a switch position, for example the zero position as described with respect to FIG. 2a, and it can be connected electrically to a load or another. The contact face 40a is therefore switched on in the illustrated switch position, while there is no contact with the other contact faces 40b, 40c, 40d, 40e of the first contact path 40. The latter are therefore switched off.

Of course, for a zero position in which there is currently intended to be no function connected with the switching, the corresponding contact face 40a can be omitted or not have an electric connection.

In this context, various forms of the contact paths 30, 40, of the notches and of the arrangement of the contact faces are within the scope of knowledge of a person skilled in the art who can adapt the arrangement and shape thereof to the respective requirements made of the switch.

Of course, the illustrated embodiments are merely exemplary, and a large number of possible variations of the present invention are obvious to a person skilled in the art.

1. A switch for switching electric contacts manually, comprising:
an operator control element configured to be displaced manually by a movement; and
at least one contact element configured to be displaced along a first contact path by the movement of the operator control element,
wherein the operator control element and the at least one contact element interact directly with one another in a contactless fashion.

2. The switch as claimed in claim 1, wherein the operator control element and the contact element are magnetic or magnetizable in at least one section.

3. The switch as claimed in claim 2, wherein the magnetic section comprises a permanent magnet.

4. The switch as claimed in claim 2, wherein the magnetic section comprises an electromagnet.

5. The switch as claimed in claim 2, wherein the magnetizable section is one of ferromagnetic or paramagnetic.

6. The switch as claimed in claim 1, wherein the direct interaction forces the contact element against the first contact path.

7. The switch as claimed in claim 1, further comprising a second contact path.

8. The switch as claimed in claim 7, wherein the first contact path and the second contact path are arranged in parallel.

9. The switch as claimed in claim 1, wherein the first contact path and the second contact path each comprise at least one contact face with which an electrically conductive section is placed in electrical contact with the at least one contact element by the movement.

10. The switch as claimed in claim 7, wherein the first contact path and the second contact path comprise at least one notch, wherein the at least one notch corresponds to a switch position.

11. The switch as claimed in claim 1, wherein the operator control element is mounted to be rotatable about a rotational axis.

12. The switch as claimed in claim 11, wherein the contact element is arranged radially with respect to the rotational axis of the operator control element.

13. The switch as claimed in claim 11, wherein the contact element is arranged parallel to the rotational axis.

14. The switch as claimed in claim 1, wherein the operator control element and the at least one contact element are displaced linearly parallel to one another.
